(19) United States
(12) Patent Application Publication
(10) Pub. No.: US 2015/0278752 A1
(43) Pub. Date: Oct. 1, 2015

(54) PRODUCTION SCHEDULE PLANNING SUPPORT METHOD AND PRODUCTION SCHEDULE PLANNING SUPPORT APPARATUS

(71) Applicant: FUJITSU LIMITED, Kawasaki-shi (JP)

(72) Inventors: Jin Ishii, Nagoya (JP); Tatsuya Ishihara, Yokohama (JP); Hirotaka Ito, Kasugai (JP)

(73) Assignee: FUJITSU LIMITED

(21) Appl. No.: 14/611,667

(22) Filed: Feb. 2, 2015

(30) Foreign Application Priority Data
Mar. 28, 2014 (JP) 2014-070541

(51) Int. Cl. G06Q 10/06; G06Q 10/10

(52) U.S. Cl. CPC G06Q 10/063114; G06Q 10/1097; G06Q 10/06316

(57) ABSTRACT

A non-transitory computer-readable recording medium stores therein a production schedule planning support program. The production schedule planning support program causes a computer to execute a process including: extracting, upon receipt of input in which a first task included in a production schedule is selected, a completion time of a second task to be completed before start of the first task and a start time of a third task to be started after completion of the first task; and outputting a movable time range of the first task that is between the completion time of the second task and the start time of the third task.

### CROSS-REFERENCE TO RELATED APPLICATION

This application is based upon and claims the benefit of priority of the prior Japanese Patent Application No. 2014-070541, filed on Mar. 28, 2014, the entire contents of which are incorporated herein by reference.

### FIELD

The embodiments discussed herein are directed to a production schedule planning support program, a production schedule planning support method, and a production schedule planning support apparatus.

### BACKGROUND

There has been conventional software that manages a production schedule about products and the like by displaying a Gantt chart and editing each task object on the Gantt chart. In such production schedule management using a Gantt chart, a task object is moved when a production schedule is desired to be modified. For example, when no task start and no task completion of this moved task object is included from the completion of a pre-process until a task start of a post-process, a warning is displayed.

Patent Document 1: Japanese Laid-open Patent Publication No. 2009-37587

In the above-mentioned technique, a warning is displayed after a task object is moved. Therefore, an administrator planning and managing a production schedule is unable to know a movable range until a task object is moved, and has difficulty in editing the production schedule.

### SUMMARY

According to an aspect of an embodiment, a non-transitory computer-readable recording medium stores therein a production schedule planning support program. The production schedule planning support program causes a computer to execute a process including: extracting, upon receipt of input in which a first task included in a production schedule is selected, a completion time of a second task to be completed before start of the first task and a start time of a third task to be started after completion of the first task; and outputting a movable time range of the first task that is between the completion time of the second task and the start time of the third task.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a schematic configuration of a whole system;

FIG. 2 illustrates an example of a functional configuration of a production schedule planning support apparatus;

FIG. 3 illustrates an example of a data configuration of task information;

FIG. 4 illustrates an example of a data configuration of item configuration information;

FIG. 5 illustrates the production relation of items;

FIG. 6 illustrates an example of the data that represents changes in inventories of the items;

FIG. 7 illustrates an example of a production schedule screen on which a production schedule is displayed;

FIG. 8 illustrates an example of a state in which a task object on a Gantt chart is selected;

FIG. 9 illustrates another example of a state in which a task object on the Gantt chart is selected;

FIG. 10 illustrates another example of a state in which a task object on the Gantt chart is selected;

FIG. 11 illustrates another example of a state in which a task object on the Gantt chart is selected;

FIG. 12 is a flowchart that illustrates an example of the procedures of output processing; and

FIG. 13 illustrates a computer that executes a production schedule planning support program.

### DESCRIPTION OF EMBODIMENTS

Preferred embodiments of a production schedule planning support program, a production schedule planning support method, and a production schedule planning support apparatus according to the present invention will be explained with reference to accompanying drawings. It should be noted that the embodiments are not intended to limit the scope of the invention. Each of the embodiments may be combined as appropriate to the extent that no inconsistency occurs in processing contents.

### [a] First Embodiment

### Configuration of System

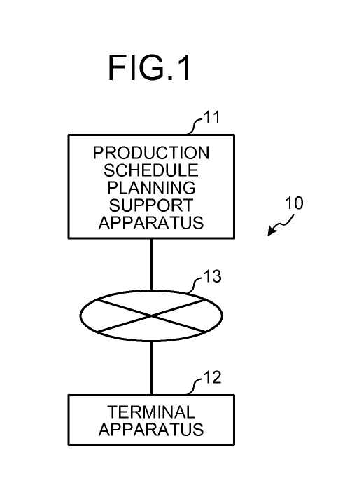

A description will be made of a system 10 according to a first embodiment. FIG. 1 illustrates an example of a schematic configuration of the whole system. As illustrated in FIG. 1, the system 10 supports the planning of a production schedule about products and the like. The system 10 includes a production schedule planning support apparatus 11 and a terminal apparatus 12. The production schedule planning support apparatus 11 and the terminal apparatus 12 are configured to be capable of exchanging various kinds of information. For example, the production schedule planning support apparatus 11 and the terminal apparatus 12 are configured to be communicably connected to each other through a network 13 and to be capable of exchanging various kinds of information. Examples of the network 13 may include, by wire or wireless, mobile communication such as a mobile phone, the Internet, and any kind of communication network such as a local area network (LAN) and a virtual private network (VPN).

The terminal apparatus 12 is a computer used by an administrator planning and managing a production schedule for inputting and referring to the production schedule. Examples of the terminal apparatus 12 include a desktop type personal computer (PC) and a laptop type PC. An administrator transmits various kinds of operation instructions related to a production schedule to the production schedule planning support apparatus 11 using the terminal apparatus 12, and plans the production schedule using the production schedule planning support apparatus 11. The example of FIG. 1 illustrates one terminal apparatus 12, but the number of the terminal apparatus 12 is not limited to this and may be optional.

The production schedule planning support apparatus 11 executes various kinds of processing related to a production schedule. Examples of the production schedule planning support apparatus 11 include computers such as a server computer. The production schedule planning support apparatus 11 may be implemented as one computer or may be implemented as a cloud including a plurality of computers. For example, the production schedule planning support apparatus 11 may be implemented as an application server that executes various kinds of processing related to a production schedule and as a database server that stores therein various kinds of information related to a production schedule. The production schedule planning support apparatus 11 may be implemented as a stand-alone apparatus directly operated by an administrator. The embodiment describes a case where one computer serves as the production schedule planning support apparatus 11 as an example. The production schedule planning support apparatus 11 causes software supporting the planning of a production schedule to operate and execute processing depending on a request received from the terminal apparatus 12. The production schedule planning support apparatus 11 generates information on the processing result such as image information resulting from the executed processing, and transmits the generated information to the terminal apparatus 12 which is a request source.

Configuration of Production Schedule Planning Support Apparatus

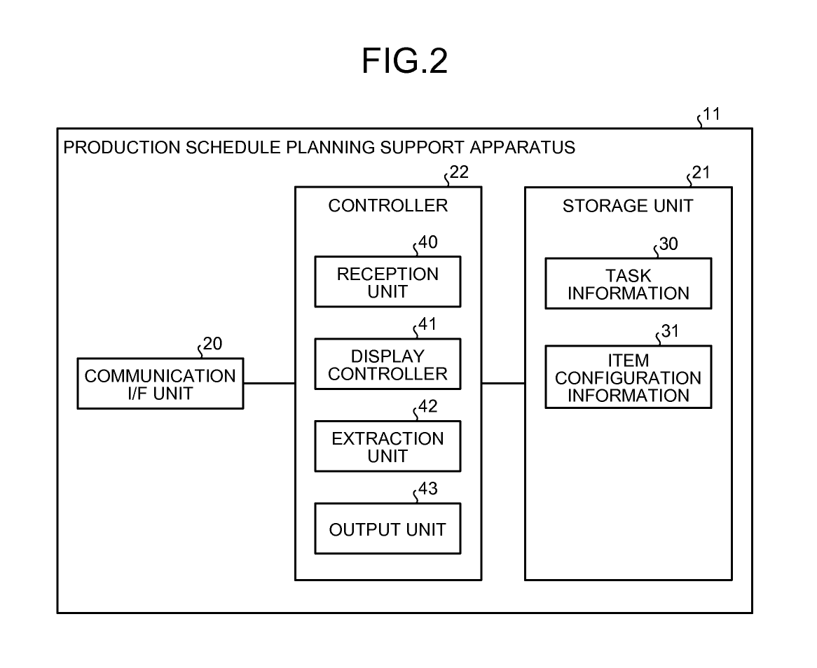

A description will be made of the production schedule planning support apparatus 11 according to the embodiment. FIG. 2 illustrates an example of a functional configuration of the production schedule planning support apparatus. As illustrated in FIG. 2, the production schedule planning support apparatus 11 includes a communication interface (I/F) unit 20, a storage unit 21, and a controller 22. The production schedule planning support apparatus 11 may include various kinds of known functional units other than the function units illustrated in FIG. 2. For example, the production schedule planning support apparatus 11 may include an input unit for inputting various kinds of information and a display unit for displaying various kinds of information.

The communication I/F unit 20 is an interface that controls communication with other apparatuses. The communication I/F unit 20 transmits and receives various kinds of information to and from other apparatuses through the network 13. For example, the communication I/F unit 20 receives various kinds of operation instructions related to a production schedule from the terminal apparatus 12. The communication I/F unit 20 transmits image information resulting from the processing executed corresponding to the operation instructions to the terminal apparatus 12. Examples of the communication I/F unit 20 include network interface cards such as a local area network (LAN) card.

The storage unit 21 is a storage device that stores therein various kinds of data. Examples of the storage unit 21 include storage apparatuses such as a hard disk, a solid state drive (SSD), and an optical disk. The storage unit 21 may be semiconductor memories capable of rewriting data such as random access memory (RAM), flash memory, and non volatile static random access memory (NVSRAM).

The storage unit 21 stores therein an operating system (OS) and various kinds of computer programs executed by the controller 22. For example, the storage unit 21 stores therein various kinds of computer programs including a production schedule planning support program for executing the later-mentioned output processing. In addition, the storage unit 21 stores therein various kinds of data used in computer programs executed by the controller 22. For example, the storage unit 21 stores therein task information 30 and item configuration information 31.

The task information 30 is data in which information related to various kinds of tasks performed in a production schedule is stored. For example, information including a produced item, a facility where a task is performed, and a task period is stored in the task information 30 for each performed task.

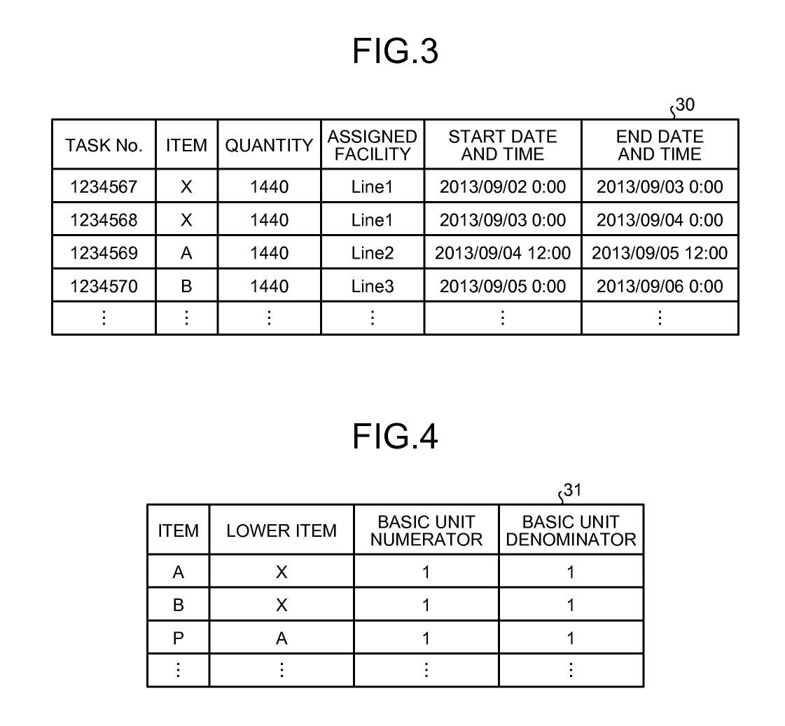

FIG. 3 illustrates an example of a data configuration of the task information. As illustrated in FIG. 3, the task information 30 includes each of the following entries: “Task No.”, “Item”, “Quantity”, “Assigned facility”, “Start date and time”, and “End date and time”. The entry of the Task No. is an area in which identification information for identifying tasks is stored. A unique task No. is given to each of the tasks as identification information for identifying each of them. The task No. given to each of the tasks is stored in the entry of the Task No. The entry of the Item is an area in which information indicating an item produced in each of the tasks is stored. The entry of the Item stores therein information such as item codes indicating items. The entry of the Quantity is an area in which quantity of the item generated by each of the tasks is stored. The entry of the Assigned facility is an area in which information indicating a facility where each of the tasks is performed is stored. In the embodiment, information related to production lines where products are produced is used as information indicating facilities. The Start date and time is an area in which a start date and time of each of the tasks is stored. The End date and time is an area in which an end date and time of each of the tasks is stored. The task information 30 may include other setting entries. For example, the task information 30 may include a deadline of production, a start enabled date of production, an entry for setting a task needed to be completed before a task, and an entry for setting a task that will be started later.

In the example of FIG. 3, the task No. “1234567” indicates a task in which the item “X” whose quantity is “1,440” pieces is produced at the assigned facility “Line 1”. The task No. “1234567” also indicates that the start date and time is “2013/9/2 0:00” and the end date and time is “2013/9/3 0:00”. The task No. “1234568” indicates a task in which the item “X” whose quantity is “1,440” pieces is produced at the assigned facility “Line 1”. The task No. “1234568” also indicates that the start date and time is “2013/9/3 0:00” and the end date and time is “2013/9/4 0:00”. The task No. “1234569” indicates a task in which the item “A” whose quantity is “1,440” pieces is produced at the assigned facility “Line 2”. The task No. “1234569” also indicates that the start date and time is “2013/9/4 12:00” and the end date and time is “2013/9/5 12:00”. The task No. “1234570” indicates a task in which the item “B” whose quantity is “1,440” pieces is produced at the assigned facility “Line 3”. The task No. “1234570” also indicates that the start date and time is “2013/9/5 0:00” and the end date and time is “2013/9/6 0:00”.

Referring back to FIG. 2, the item configuration information 31 is data in which information related to materials used for producing items is stored. Examples of the item configuration information 31 include information related to items forming an item.

FIG. 4 illustrates an example of a data configuration of the item configuration information. As illustrated in FIG. 4, the item configuration information 31 includes each of the following entries: “Item”, “Lower item”, “Basic unit numerator”, and “Basic unit denominator”. The entry of the Item is an area in which identification information on items such as item codes for indicating items is stored. The entry of the Lower item is an area in which identification information on items as materials for producing an item is stored. The entry of the Basic unit numerator is an area in which a numerator is stored when a ratio of using a lower item for producing an item is represented by a fraction. The entry of the Basic unit denominator is an area in which a denominator is stored when a ratio of using a lower item for producing an item is represented by a fraction.

In the example of FIG. 4, the item “A” is produced by using an item “X” as a material with a ratio of the basic unit numerator “1” to the basic unit denominator “1”. In other words, the item “A” is produced by using one piece of the item “X” as a material. The item “B” is produced by using the item “X” as a material with a ratio of the basic unit numerator “1” to the basic unit denominator “1”. In other words, the item “B” is also produced by using one piece of the item “X” as a material. An item “P” is produced by using the item “A” as a material with a ratio of the basic unit numerator “1” to the basic unit denominator “1”. In other words, the item “P” is produced by using one piece of the item “A” as a material. The example of FIG. 4 illustrates that one lower item is for one item, but records are registered for each lower item when there are a plurality of lower items for one item.

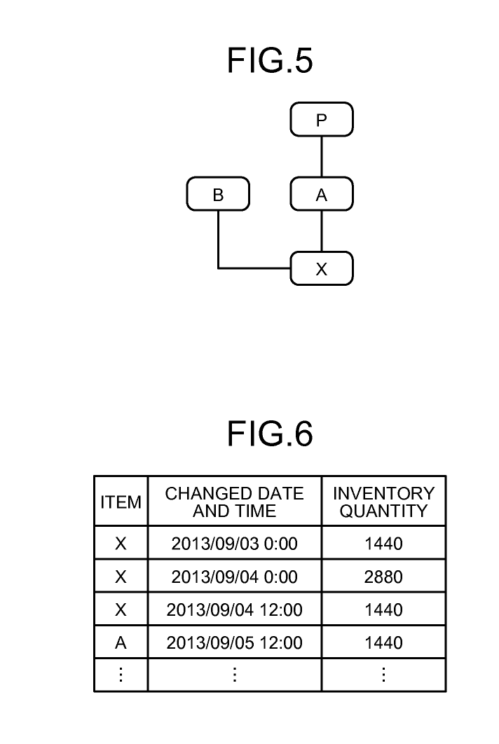

FIG. 5 illustrates the production relation of the items. The example of FIG. 5 illustrates the production relation of the items illustrated in FIG. 4. The example of FIG. 5 illustrates items produced in an upper process as the items are upper ones. In the example of FIG. 5, the item “X” is used for producing the items “A” and “B”. In the example of FIG. 5, the item “A” is used for producing the item “P”.

Referring back to FIG. 2, the controller 22 is a device that controls the production schedule planning support apparatus 11. Examples of the controller 22 include electronic circuits such as a central processing unit (CPU) and a micro processing unit (MPU), and integrated circuits such as an application specific integrated circuit (ASIC) and a field programmable gate array (FPGA). The controller 22 includes an internal memory for storing computer programs that specify various kinds of processing procedures and control data, and executes various kinds of processing using the computer programs and the control data. The controller 22 functions as a processing unit of each kind by causing various kinds of computer programs to operate. For example, the controller 22 includes a reception unit 40, a display controller 41, an extraction unit 42, and an output unit 43.

The reception unit 40 performs various kinds of reception. For example, the reception unit 40 receives various kinds of operation instructions related to a production schedule. For example, the reception unit 40 receives various kinds of operation instructions related to a production schedule transmitted from the terminal apparatus 12.

The display controller 41 controls the display of various kinds of screens. For example, the display controller 41 displays various kinds of screens related to a production schedule on the terminal apparatus 12. For example, the display controller 41 displays a screen that illustrates a production schedule about products and the like using a Gantt chart on the terminal apparatus 12. The display controller 41 updates various kinds of screens related to a production schedule displayed on the terminal apparatus 12 depending on the operation instructions received by the reception unit 40.

The extraction unit 42 performs various kinds of extraction. For example, after receiving input in which a task included in a production schedule displayed as a Gantt chart is selected, the extraction unit 42 extracts a completion time of a task needed to be completed before the selected task and a start time of a task capable of being started after completion of the selected task. For example, when there is a second task needed to be completed before a selected first task, the extraction unit 42 extracts a completion time of the second task. When there is a third task to be started after completion of the first task, the extraction unit 42 extracts a start time of the third task. The first task can be executed in a period between the completion time of the second task and the start time of the third task. When there is no task needed to be completed before a selected task or no task capable of being started after the selected task, the extraction unit 42 may extract no start time and no end time.

The extraction unit 42 obtains changes in inventories of an item related to a selected task along with a production schedule on the assumption that there is no selected task. For example, the extraction unit 42 obtains changes in inventories of an item along with a production schedule on the assumption that there is no selected task, an item used in a task is used at a start date and time of the task, and an item of the task is produced at an end date and time. In the embodiment, an item used in a task is used at a start date and time of the task and an item of the task is produced at an end date and time, but this is not limiting. For example, an item may be produced and used equally between a start date and time and an end date and time of a task. For example, an item may be produced and used each at predetermined ratio and for each predetermined period between a start date and time and an end date and time of a task.

FIG. 6 illustrates an example of the data that represents changes in inventories of the items. The example of FIG. 6 is a result in which changes in inventories related to the items “X” and “A” are obtained along with the task information 30 illustrated in FIG. 3. The initial inventories of the items “X” and “A” are zero. For example, as illustrated in FIG. 3, the task of the task No. “1234567” causes “1,440” pieces of the item “X” to be produced at the end date and time of “2013/9/3 0:00”. Thus, in the example of FIG. 6, the inventories of the item “X” are represented as “1,440” pieces at the changed date and time of “2013/9/3 0:00”. As illustrated in FIG. 3, the task of the task No. “1234568” causes “1,440” pieces of the item “X” to be produced at the end date and time of “2013/9/4 0:00”. Thus, in the example of FIG. 6, the inventories of the item “X” are represented as “2,880” pieces at the changed date and time of “2013/9/4 0:00”. As illustrated in FIG. 3, the task of the task No. “1234569” causes the item “A” to be produced using the item “X” at the start date and time of “2013/9/4 12:00”. Thus, in the example of FIG. 6, the inventories of the item “X” are represented as “1,440” pieces at the changed date and time of “2013/9/4 12:00”. As illustrated in FIG. 3, the task of the task No. “1234569” causes “1,440” pieces of the item “A” to be produced at the end date and time of “2013/9/5 12:00”. Thus, in the example of FIG. 6, the inventories of the item “A” are represented as “1,440” pieces at the changed date and time of “2013/9/5 12:00”.

The extraction unit 42 extracts a start date and time and an end date and time of a movable range of a selected task from changes in inventories of an item related to the selected task. For example, the extraction unit 42 extracts the earliest time at which a certain number of components to be used in a selected task can be secured, the certain number being equal to or more than the number of components to be used in the task, as a start date and time of a movable range. For example, the extraction unit 42 traces changes in inventories back in time from a start date and time of a selected task, and extracts the earliest time in the range where the number of inventories of components used in the selected task is not less than the number of components to be used in the task.

The extraction unit 42 obtains the latest time at which a certain number of components to be used in a selected task can be secured, the certain number being equal to or more than the number of components to be used in the task. When components produced in the selected task are used in a subsequent task, the extraction unit 42 obtains the latest time at which a certain number of components equal to or more than the number of components to be used in the subsequent task can be secured. The extraction unit 42 extracts the earlier time from the obtained times as an end time of a movable range.

The output unit 43 performs various kinds of output. For example, the output unit 43 outputs a movable time range of a selected task. For example, the output unit 43 outputs a start date and time and an end date and time of a movable time range of the selected task on a screen.

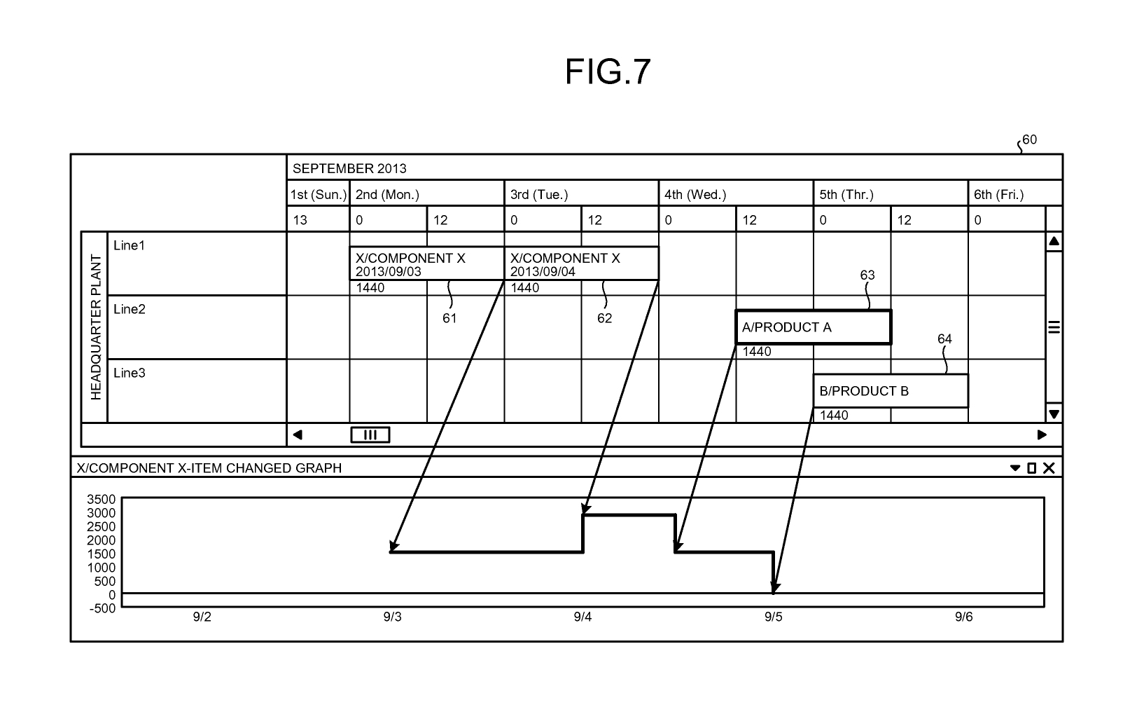

A description will be made with concrete examples. FIG. 7 illustrates an example of a production schedule screen on which a production schedule is displayed. A production schedule screen 60 illustrated in FIG. 7 illustrates a Gantt chart in which task objects indicating planned tasks are placed for each production line.

In the example of FIG. 7, tasks 61 and 62 are planned in a production line “Line 1”. In the task 61, 1,440 pieces of the item “X” are produced between “2013/9/2 0:00” and “2013/9/3 0:00”. In the task 62, 1,440 pieces of the item “X” are produced between “2013/9/3 0:00” and “2013/9/4 0:00”. In the example of FIG. 7, a task 63 is planned in a production line “Line 2”. In the task 63, 1,440 pieces of the item “A” are produced between “2013/9/4 12:00” and “2013/9/5 12:00”. In the example of FIG. 7, a task 64 is planned in a production line “Line 3”. In the task 64, 1,440 pieces of the item “B” are produced between “2013/9/5 0:00” and “2013/9/6 0:00”.

The lower part of FIG. 7 illustrates changes in inventories of components of the item “X”. The components of the item “X” are produced in the tasks 61 and 62, and the number thereof is changed from 0 to 1,440 pieces and to 2,880 pieces corresponding to the end date and times of the tasks 61 and 62. The components of “X” are used in the tasks 63 and 64, and the number thereof is changed from 2,880 pieces to 1,440 pieces and to 0 corresponding to the start times of the tasks 63 and 64.

When modifying a production schedule, an administrator selects and moves a task object of each of the tasks on the Gantt chart illustrated on the production schedule screen 60.

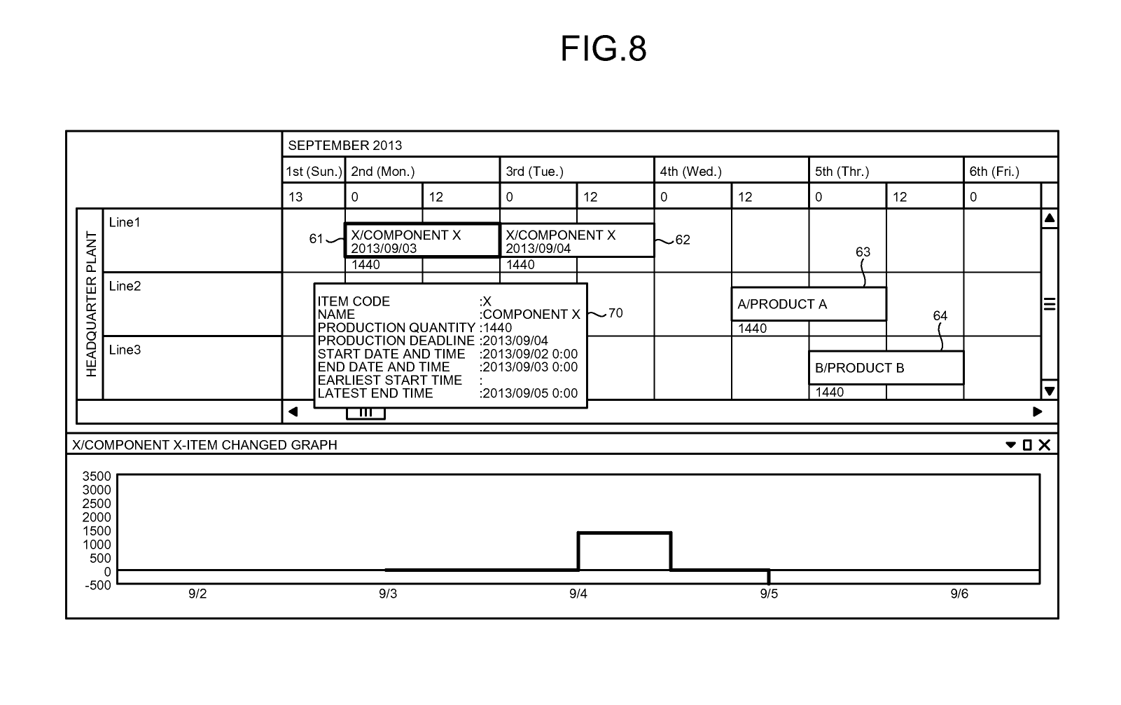

FIG. 8 illustrates an example of a state in which a task object on the Gantt chart is selected. The example of FIG. 8 illustrates a state in which a task object of the task 61 is selected. In this case, the extraction unit 42 obtains changes in inventories of an item related to the task 61 along with a production schedule on the assumption that there is no task 61. For example, the extraction unit 42 obtains changes in inventories of components of the item “X” produced in the task 61. The lower part of FIG. 8 illustrates changes in inventories of components of the item “X” when there is no task 61. The changes in inventories illustrated in the lower part of FIG. 8 illustrate that the inventories of components of the item “X” become negative at the time of starting the task 64.

When there is a task needed to be completed before a selected task, the extraction unit 42 extracts a completion time of the task needed to be completed. When there is a task to be started after completion of the selected task, the extraction unit 42 extracts a start time of the task to be started later. For example, when a predetermined task (not illustrated) is defined as a task needed to be completed before the task 61, the extraction unit 42 extracts a completion time of the predetermined task. For example, when the task 63 is defined as a task to be started after the task 61, the extraction unit 42 extracts a start time of the task 63. In the embodiment, no task needed to be completed in advance or no task to be started later is set to each of the tasks. Therefore, the extraction unit 42 extracts no start time and no end time in the embodiment.

In the selected task 61, components used in the task are always secured, and producing the components used in the task can be delayed. However, components of the item “X” are insufficient at the time of starting the task 64. Therefore, the extraction unit 42 extracts a start date and time of the task 64 as an end time of a movable range. When a deadline of production is set to a task, the extraction unit 42 may define, if an end time of a movable range is after the deadline, the end time of the movable range as a date and time of the deadline.

In the selected task 61, components used in the task are always secured, and producing the components used in the task can be advanced. In this case, the extraction unit 42 extracts, for example, the earliest time at which the task 61 can be started as a start date and time of a movable range. The earliest date and time at which the task 61 can be started in a production schedule is defined as a start date and time of a movable range. When a date capable of starting production for a task is defined as a production enabling date, the extraction unit 42 may define, if the earliest date and time capable of starting production is after the production enabling date, a start date and time of a movable range as a production enabling date.

The output unit 43 outputs a movable time range of a selected task on a screen. In the production schedule screen 60 illustrated in FIG. 8, when a task is selected, information related to the selected task is represented by a balloon display 70. The output unit 43 outputs a movable time range of the selected task to the balloon display 70. In the production schedule screen 60 illustrated in FIG. 8, the balloon display 70 represents an item code to be produced, a name, production quantity, a production deadline, a task start date, a task end date, an earliest start time, and a latest end time about the selected task. The item code represents an item code of components. The name represents an item name corresponding to the item code. The production quantity represents the quantity of an item to be produced by a task. The production deadline represents a deadline of production. The task start date represents a start date and time of the current task. The task end date represents a end date and time of the current task. The earliest start time represents a start date and time of a movable time range. The latest end time represents an end date and time of a movable time range. In the embodiment, when representing the earliest date and time at which the task 61 can be started in a production schedule, the earliest start time is made blank. Thus, the earliest start time is made blank in the example of FIG. 8.

An operator can recognize a movable time range of a selected task from information on a movable time range output as the earliest start time and the latest end time on a screen. In the example of FIG. 8, an operator refers to the balloon display 70 so as to recognize that the task 61 can be delayed until “2013/9/5 0:00”.

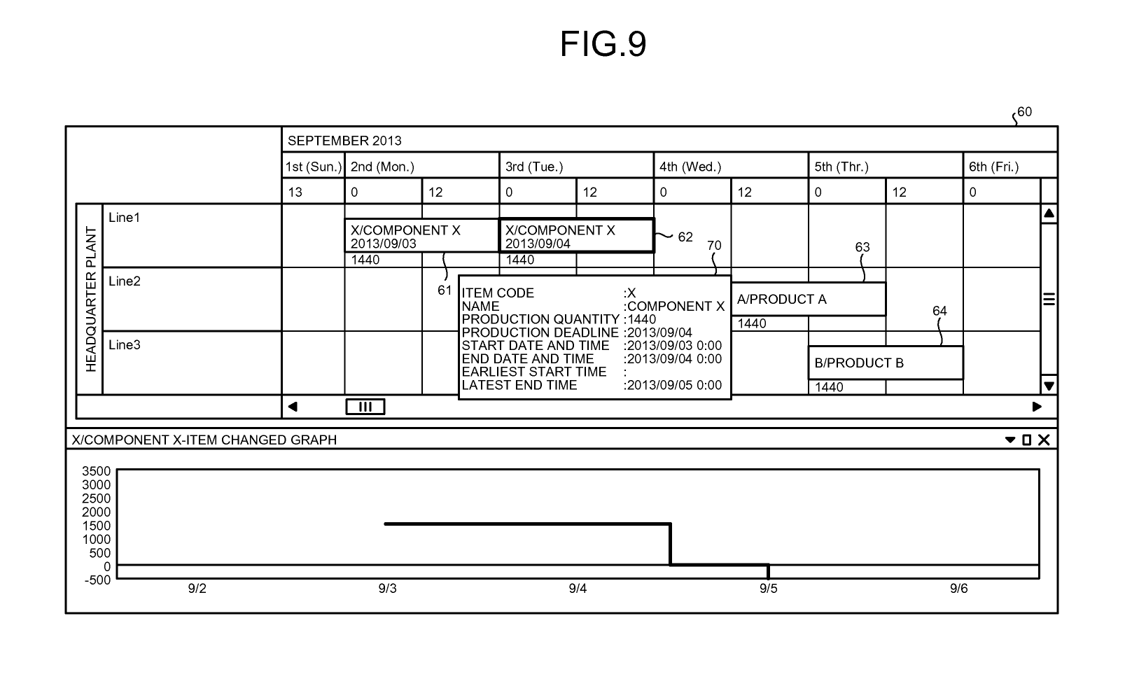

FIG. 9 illustrates another example of a state in which a task object on the Gantt chart is selected. The example of FIG. 9 illustrates a state in which a task object of the task 62 is selected. In this case, the extraction unit 42 obtains changes in inventories of an item related to the task 62 along with a production schedule on the assumption that there is no task 62. For example, the extraction unit 42 obtains changes in inventories of components of the item “X” produced in the task 62. The lower part of FIG. 9 illustrates changes in inventories of components of the item “X” when there is no task 62. The changes in inventories illustrated in the lower part of FIG. 9 illustrate that the inventories of components of the item “X” are produced in the task 61 and the number thereof is 1,440 pieces on “2013/9/3 0:00”.

In the selected task 62, components used in the task are always secured, and producing the components used in the task can be delayed. However, components of the item “X” are insufficient at the time of starting the task 64. Therefore, the extraction unit 42 extracts a start date and time of the task 64 as an end time of a movable range. In the selected task 62, components used in the task are always secured, and producing the components used in the task can be advanced. In this case, the extraction unit 42 extracts the earliest date and time at which the task 62 can be started in a production schedule as a start date and time of a movable range. The output unit 43 outputs a movable time range of the selected task 62 to the balloon display 70. In the example of FIG. 9, an operator refers to the balloon display 70 so as to recognize that the task 62 can be delayed until “2013/9/5 0:00”.

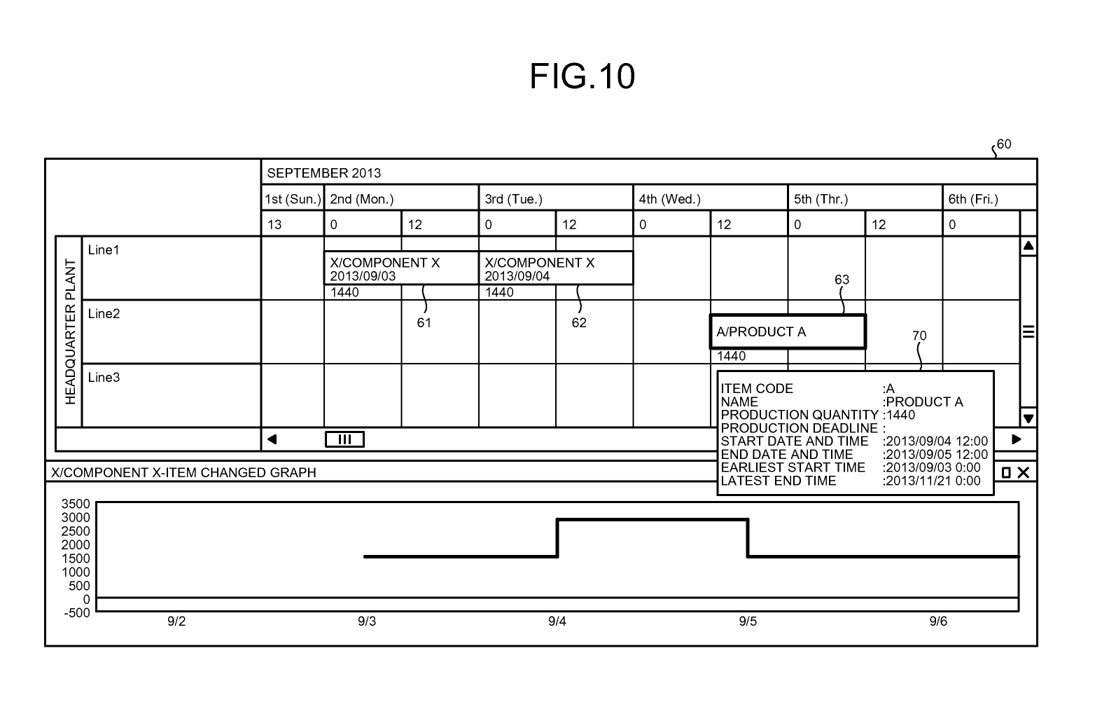

FIG. 10 illustrates another example of a state in which a task object on the Gantt chart is selected. The example of FIG. 10 illustrates a state in which a task object of the task 63 is selected. In this case, the extraction unit 42 obtains changes in inventories of an item related to the task 63 along with a production schedule on the assumption that there is no task 63. For example, the extraction unit 42 obtains changes in inventories of components of the item “X” used in the task 63. The lower part of FIG. 10 illustrates changes in inventories of components of the item “X” when there is no task 63. The changes in inventories illustrated in the lower part of FIG. 10 illustrate that the inventories of components of the item “X” are produced in the task 61 and the number thereof is 1,440 pieces on “2013/9/3 0:00”, and that the inventories are furthermore produced in the task 62 and the number thereof is 2,880 pieces on “2013/9/4 0:00”.

In the selected task 63, components “X” used in a task are always secured, and producing the components used in the task can be delayed. In this case, the extraction unit 42 extracts, for example, the latest time at which the task 63 can be started as an end date and time of a movable range. The extraction unit 42 extracts “2013/11/21 0:00” serving as an end date and time of a production schedule as an end date and time of a movable range. Before the task 61, the number of inventories of the component “X” is less than the number of components to be used in the task 63 of “1,440” pieces. Therefore, the extraction unit 42 extracts an end date and time of the task 61 as a start date and time of a movable range. The output unit 43 outputs a movable time range of the selected task 63 to the balloon display 70. In the example of FIG. 10, an operator refers to the balloon display 70 so as to recognize that a task period of the task 63 can be changed in the range from “2013/9/3 0:00” to “2013/11/21 0:00”.

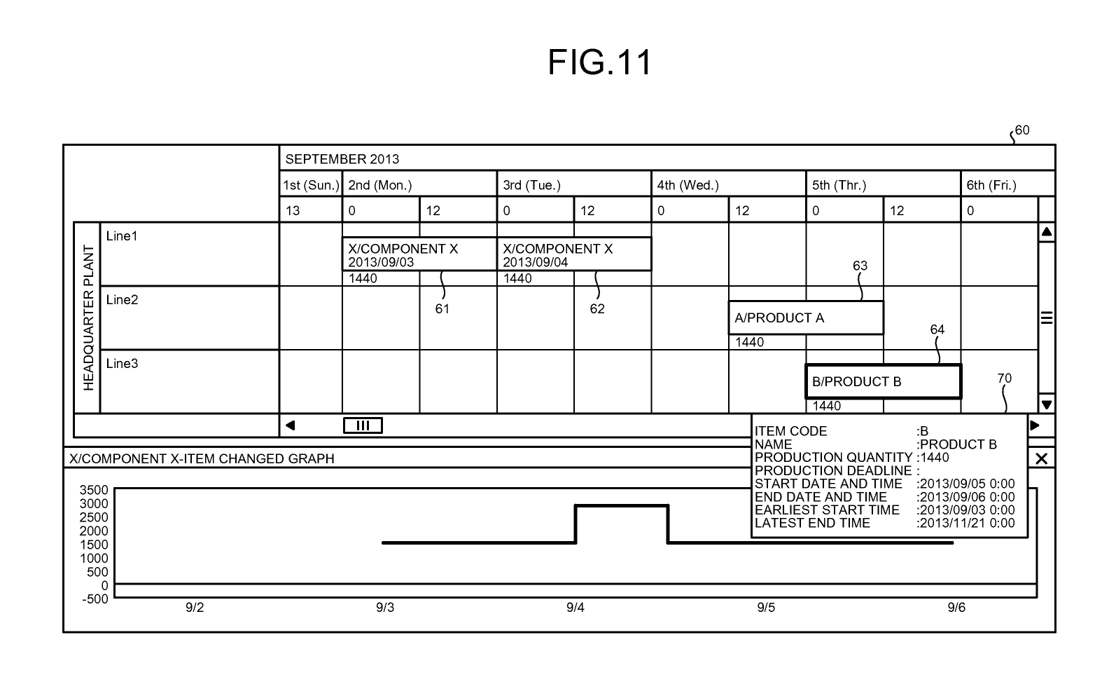

FIG. 11 illustrates another example of a state in which a task object on the Gantt chart is selected. The example of FIG. 11 illustrates a state in which a task object of the task 64 is selected. In this case, the extraction unit 42 obtains changes in inventories of an item related to the task 64 along with a production schedule on the assumption that there is no task 64. For example, the extraction unit 42 obtains changes in inventories of components of the item “X” used in the task 64. The lower part of FIG. 11 illustrates changes in inventories of components of the item “X” when there is no task 64. The changes in inventories illustrated in the lower part of FIG. 11 illustrate that the inventories of components of the item “X” are produced in the task 61 and the number thereof is 1,440 pieces on “2013/9/3 0:00”, and that the inventories are furthermore produced in the task 62 and the number thereof is 2,880 pieces on “2013/9/4 0:00”.

In the selected task 64, the components “X” used in a task are always secured, and producing the components used in the task can be delayed. In this case, the extraction unit 42 extracts, for example, the latest time at which the task 64 can be started as an end date and time of a movable range. The extraction unit 42 extracts “2013/11/21 0:00” as an end date and time of a movable range. Before the task 61, the number of inventories of the components “X” is less than the number of components to be used in the task 64 of “1,440” pieces. Therefore, the extraction unit 42 extracts an end date and time of the task 61 as a start date and time of a movable range. The output unit 43 outputs a movable time range of the selected task 64 to the balloon display 70. In the example of FIG. 11, an operator refers to the balloon display 70 so as to recognize that a task period of the task 64 can be changed in the range from “2013/9/3 0:00” to “2013/11/21 0:00”.

Processing Flow

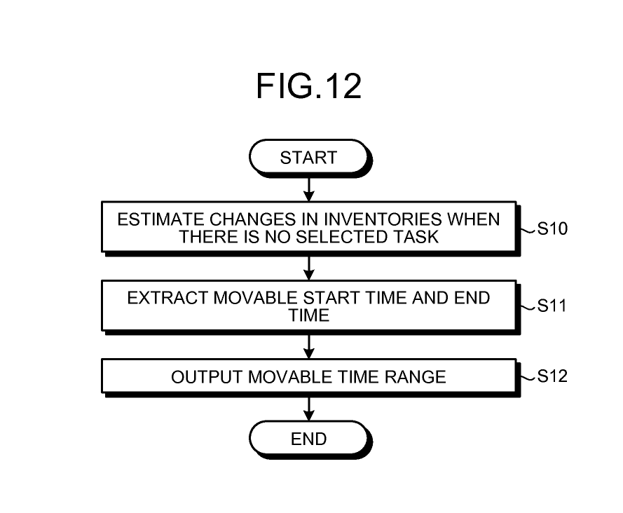

A description will be made of an output processing flow in which the production schedule planning support apparatus 11 according to the embodiment outputs a movable time range of a task. FIG. 12 is a flowchart that illustrates an example of the procedures of output processing. This output processing is executed at a predetermined timing, for example, at a timing when a task object is selected on the production schedule screen 60.

As illustrated in FIG. 12, the extraction unit 42 estimates changes in inventories of an item related to a selected task along with a production schedule on the assumption that there is no task of the selected task object (step S10). The extraction unit 42 extracts a start date and time and an end date and time of a movable range of the selected task from the changes in inventories of an item related to the selected task (step S11). The output unit 43 outputs a start date and time and an end date and time of a movable time range of the selected task on a screen (step S12), and the processing ends.

### Effects

As described above, when receiving input in which a first task included in a production schedule is selected, the production schedule planning support apparatus 11 according to the embodiment extracts a completion time of a second task needed to be completed before the first task and a start time of a third task capable of being started after completion of the first task. The production schedule planning support apparatus 11 outputs a movable time range of the first task that is between the completion time of the second task and the start time of the third task. In this manner, the production schedule planning support apparatus 11 is conscious of restriction conditions so as to edit the production schedule.

The production schedule planning support apparatus 11 according to the embodiment obtains changes in the number of inventories of use components used in the first task and changes in the number of inventories of production components produced in the first task on the assumption that there is no first task. The production schedule planning support apparatus 11 extracts the earlier time out of the latest time at which a certain number of use components equal to or more than the number of components to be used in the first task can be secured and the latest time at which a certain number of production components equal to or more than the number of components to be used in the third task can be secured, as an end time. The production schedule planning support apparatus 11 outputs the extracted end time as an end time of a movable time range of the first task. In this manner, the production schedule planning support apparatus 11 is conscious of the movable end time of the first task in the production schedule so as to edit the production schedule.

The production schedule planning support apparatus 11 according to the embodiment obtains changes in the number of inventories of use components used in the first task on the assumption that there is no first task. The production schedule planning support apparatus 11 extracts the earliest time at which a certain number of use components equal to or more than the number of components to be used in the first task can be secured. The production schedule planning support apparatus 11 outputs the earliest time as a start time of a movable time range of the first task. In this manner, the production schedule planning support apparatus 11 is conscious of the movable start time of the first task in the production schedule so as to edit the production schedule.

### [b] Second Embodiment

A description has been made of the embodiment related to the disclosed apparatus, but the disclosed technique may be implemented in various different embodiments other than the above-mentioned embodiment. Another embodiment included in the present invention will be described below.

For example, the above-mentioned embodiment describes a case where a period when the number of components to be used in a task can be secured is defined as a movable period of a task in the production schedule planning support apparatus 11, but the disclosed apparatus is not limited to this. For example, a margin may be provided to necessary inventories. For example, a predetermined threshold or a margin at a predetermined ratio may be provided to necessary inventories, and a period when a certain number of components equal to or more than the number of components to be used can be secured may be a movable period of a task. An administrator may uniformly set this marginal threshold or ratio as a whole, or may individually set this threshold or ratio.

Each component of each of the illustrated apparatuses is something functionally conceptual, and is not necessarily configured physically as illustrated. In other words, a specific state of distributing/integrating each of the apparatuses is not limited to the illustrated states, and all of or a part of the apparatuses can be configured to be functionally or physically distributed/integrated in a certain unit depending on various kinds of loads and use situations. For example, each of the processing units of the reception unit 40, the display controller 41, the extraction unit 42, and the output unit 43 may be integrated as appropriate. Processing executed by each of the processing units may be separated into processing executed by a plurality of processing units as appropriate. All of or any part of the processing functions executed by each of the processing units may be achieved by a CPU or a computer program analyzed and executed by the CPU, or may be achieved as hardware based on the wired logic.

Production Schedule Planning Support Program

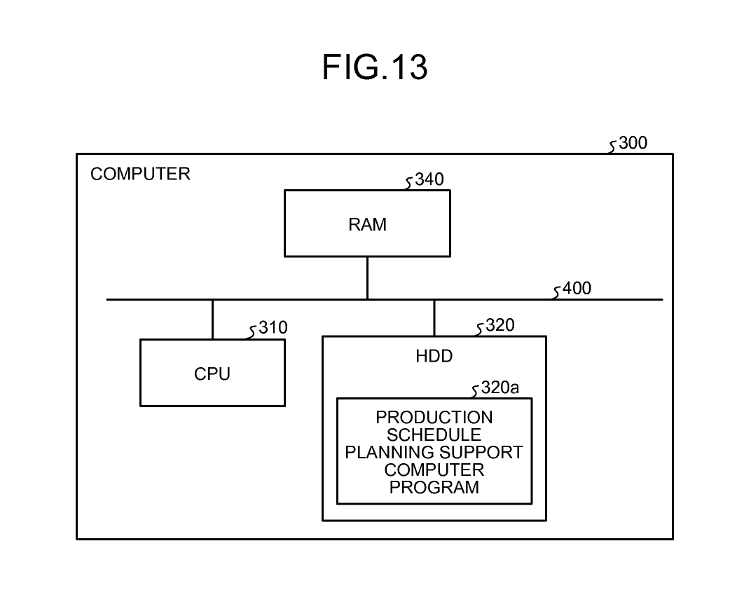

Various kinds of processing described in the embodiments may be achieved by executing a preliminarily prepared computer program with the use of computer systems such as a personal computer and a work station. A description will be made of an example of a computer system that executes a computer program having the same functions as those of the embodiments. FIG. 13 illustrates a computer that executes a production schedule planning support program.

As illustrated in FIG. 13, a computer 300 includes a central processing unit (CPU) 310, a hard disk drive (HDD) 320, and a random access memory (RAM) 340. Each of these units 300 to 340 is connected to each other through a bus 400.

The HDD 320 preliminary stores therein a production schedule planning support program 320a that exerts the same functions as those of the reception unit 40, the display controller 41, the extraction unit 42, and the output unit 43. The production schedule planning support program 320a may be separated as appropriate.

The HDD 320 stores therein various kinds of information. For example, the HDD 320 stores therein an operating system (OS) and various kinds of data used for estimating a moving direction to a tracking object terminal.

The CPU 310 reads and executes the production schedule planning support program 320a from the HDD 320 so as to execute the same operation as that of each of the processing units in the embodiments. In other words, the production schedule planning support program 320a executes the same operation as that of the reception unit 40, the display controller 41, the extraction unit 42, and the output unit 43.

The production schedule planning support program 320a described above is not necessarily stored in the HDD 320 from the beginning.

For example, a computer program is stored in “portable physical media” such as a flexible disk (FD), a compact disc read-only memory (CD-ROM), a digital versatile disc (DVD), a magneto-optical disk, and an integrated circuit (IC) card inserted into the computer 300. The computer 300 may read and execute the computer program from the portable physical media.

Furthermore, a computer program may be stored in “other computers (or servers)” connected to the computer 300 through a public line, the Internet, a local area network (LAN), a wide area network (WAN), and the like. The computer 300 may read and execute the computer program from the other computers.

An aspect of embodiments of the invention enables a user to be conscious of restriction conditions and edit a production schedule.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a production schedule planning support program causing a computer to execute a process comprising:
extracting, upon receipt of input in which a first task included in a production schedule is selected, a completion time of a second task to be completed before start of the first task and a start time of a third task to be started after completion of the first task; and
outputting a movable time range of the first task that is between the completion time of the second task and the start time of the third task.

2. The non-transitory computer-readable recording medium according to claim 1, wherein
the extracting includes obtaining changes in number of inventories of use components used in the first task and changes in number of inventories of production components produced in the first task on an assumption that there is no first task, and extracting an end time that is earlier time out of latest time at which a number of use components to be used in the first task is secured and latest time at which a number of production components to be used in the third task is secured, and
the outputting includes outputting the extracted end time as an end time of the movable time range of the first task.

3. The non-transitory computer-readable recording medium according to claim 1, wherein
the extracting includes obtaining changes in number of inventories of use components used in the first task on an assumption that there is no first task, and extracting earliest time at which a number of use components to be used in the first task is secured, and
the outputting includes outputting the earliest time as a start time of the movable time range of the first task.

4. The non-transitory computer-readable recording medium according to claim 3, wherein the extracting includes extracting earliest time in a range where the number of inventories of components used in the first task is not less than a predetermined number equal to or more than number of use components to be used in the first task from a current task period of the first task.

5. A production schedule planning support method comprising:
extracting, upon receipt of input in which a first task included in a production schedule is selected, a completion time of a second task to be completed before start of the first task and a start time of a third task to be started after completion of the first task, using a processor; and
outputting a movable time range of the first task that is between the completion time of the second task and the start time of the third task.

6. A production schedule planning support apparatus comprising:
a processor that executes a process including:
extracting, upon receipt of input in which a first task included in a production schedule is selected, a completion time of a second task to be completed before start of the first task and a start time of a third task to be started after completion of the first task; and
outputting a movable time range of the first task that is between the completion time of the second task and the start time of the third task.
